(19) United States
(12) Patent Application Publication
(10) Pub. No.: US 2006/0027331 A1
(43) Pub. Date: Feb. 9, 2006

(54) Adhesive film sticking apparatus

(75) Inventors: Shuuji Hirai, Kameyama-shi (JP); Masaru Irie, Kameyama-shi (JP); Noriyoshi Nagata, Kameyama-shi (JP); Masayuki Yamamoto, Ibaraki-shi (JP)

Correspondence Address: OLIFF & BERRIDGE, PLC, P.O. BOX 19928, ALEXANDRIA, VA, 22320, US

(73) Assignee: NITTO DENKO CORPORATION, Ibaraki-shi (JP)

(21) Appl. No.: 11/156,484

(22) Filed: Jun. 21, 2005

(30) Foreign Application Priority Data
Aug. 6, 2004 (JP) 2004-231103

(51) Int. Cl. B65C 9/18

(52) U.S. Cl. 156/541

(57) ABSTRACT

For detection of an adhesive film adhesively provided on a base tape of a film supply tape, a front end of the adhesive film is detected based on the detection of a predetermined displacement amount of a roller contactor of a detection sensor, the roller contactor being displaceable in a direction of thickness of the adhesive film. Based on a detection signal from the detection sensor, feeding rollers and others are controlled to feed the film supply tape by a predetermined feeding amount until the front end of the adhesive film comes to near a fold-back point of the base tape by a guide member.

### BACKGROUND OF THE INVENTION

1. Field of the Invention

The present invention relates to an adhesive film sticking apparatus for sticking an adhesive film, which has a shape corresponding to that of a substrate, on a surface of the substrate in a process of surface treatments for various types of substrates such as a semiconductor substrate and a glass substrate for a liquid crystal display.

2. Description of Related Art

Heretofore, various types of film sticking apparatuses have been proposed to stick an adhesive film on a surface of each of various types of substrates, the adhesive film having a shape corresponding to the shape of each substrate.

For example, Japanese unexamined patent publication No. H7(1995)-195527 discloses an adhesive film sticking apparatus having the following structure. A film detecting mechanism detects that a headmost one of adhesive films placed on a film supply tape being fed by a film feeding means has reached a fixed position. Based on such detection, the feeding of the film supply tape is stopped. At the stop position, the relative position and relative angle of the adhesive film with respect to the substrate are corrected. Then, the substrate and the film supply tape are synchronously transported, continuously peeling the adhesive film off the supply tape at a tape fold-back point to stick the adhesive film on the substrate.

In the adhesive film sticking apparatus disclosed in the '527 publication, when the adhesive films spaced at predetermined intervals on the film supply tape in a longitudinal direction are transported in sequence to a predetermined sticking position, the presence of each adhesive film is first detected through one reflection photosensor provided in the film detecting mechanism during the feeding of the film supply tape. Further, the feeding of the film supply tape is stopped at the time when another reflection photosensor detects the rear end of each adhesive film according to each size. The stop position is set as the predetermined sticking position.

As mentioned above, the adhesive film sticking apparatus in the '527 publication is arranged to put each adhesive film provided on the film supply tape to the predetermined position by controlling the feeding of the film supply tape by use of the photosensor. In the case where the adhesive film is made of a transparent or semitransparent film having a light transmittance property, however, it is very difficult for some optical sensors such as the photosensor to reliably detect the presence of such adhesive film. In this case, the adhesive film could not be set stably in place.

To avoid the above drawbacks, a sensor other than the photosensor is used to detect an adhesive film, so that even the adhesive film having a light transmittance property can be set in the predetermined position.

For example, Japanese Patent No. 3174917 discloses an adhesive tape sticking apparatus arranged to set adhesive tapes continuously adhered on a release film in a predetermined position by detecting the edge of each adhesive tape on the release film by means of a sensor other than the photosensor.

Specifically, the adhesive tape sticking apparatus detects by using a limit switch that each adhesive tape adhered on the release film is placed in the predetermined position. A square wheel provided at the end of the limit switch is rotated upon contact with the edge of each adhesive tape, and thus a lever of the limit switch is largely moved. Accordingly, it is detected that the adhesive tape is in the predetermined position.

From FIG. 3 of the '917 patent, it is understood that the edge of each adhesive tape detected through the limit switch is a rear end in order to set each adhesive tape in the predetermined position at the time when the edge of each adhesive tape is detected through the limit switch.

However, the adhesive tape sticking apparatus disclosed in the '917 patent needs that the front end of each adhesive tape is disposed in the predetermined sticking position at the time when the rear end of each adhesive tape disposed on the release film is detected through the limit switch. Accordingly, a path length between the square wheel of the limit switch and the front end of a peel plate which peels each adhesive tape off the release film has to be equal to the size of each adhesive tape.

In the above apparatus, a tape detecting mechanism provided with the limit switch is basically fixed, so that the path length between the square wheel of the limit switch and the front end of the peel plate is determined as a fixed length. This apparatus can be operated for adhesive tapes having a uniform size arranged on a release tape; however, it is unsuitable for various-sized adhesive tapes for various-sized substrates.

Although the tape detecting mechanism can be freely moved according to the size of each adhesive tape, a work of adjusting the position of the tape detecting mechanism would be extremely troublesome.

### SUMMARY OF THE INVENTION

The present invention has been made in view of the above circumstances and has an object to overcome the above problems and to provide an adhesive film sticking apparatus capable of setting adhesive films in a predetermined sticking position by reliably detecting the edge of each adhesive film adhered and spaced at predetermined intervals on a base tape even where the adhesive films are films having a light transparent property.

Another object of the present invention is providing an adhesive film sticking apparatus that can flexibly be operate for various types of adhesive films different in size to individually set the adhesive films of any size in a predetermined sticking position.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

(1) To achieve the purpose of the invention, there is provided an adhesive film sticking apparatus comprising: a tape feed device for feeding a film supply tape on which adhesive films each having a predetermined shape are arranged at predetermined intervals in a longitudinal direction of a base tape; a film peeling device for guiding the film supply tape to be folded back to a fold-back point and peeling each adhesive film from the base tape at the fold-back point; a sticking roller placed near the fold-back point and to be movable in an up and down direction; and a sticking table for placing thereon substrates on each of which the adhesive film is to be stuck; the sticking roller and the sticking table being moved relatively to each other, thereby sequentially peeling each adhesive film from the base tape by the film peeling device and sticking each adhesive film onto each substrate by the sticking roller, wherein the adhesive film sticking apparatus further comprises: a detection device including a contactor displaceable in a direction of thickness of each adhesive film adhesively provided on the base tape of the film supply tape to be fed by the tape feed device, the detection device being adapted to detect an end of each adhesive film when a predetermined displacement of the contactor is detected; and a control device for controlling the tape feed device based on a detection signal output from the detection device so that the film supply tape is fed by a predetermined feeding amount until a front end of the adhesive film comes to near the fold-back point.

(2) In the adhesive film sticking apparatus (1), preferably, the adhesive film adhesively provided on the base tape includes a plurality of adhesive films of various sizes, and the control device changes the predetermined feeding amount according to the size of each adhesive film.

(3) In the adhesive film sticking apparatus (2), preferably, the contactor of the detection device comprises a roller contactor provided with a rotatable roller, and the apparatus further comprises a guide bar having a flat support surface and being disposed facing the roller contactor through the film supply tape.

(4) In the adhesive film sticking apparatus (3), preferably, the roller contactor is separated from the support surface of the guide bar during non-operation where the film supply tape is not fed by the tape feed device.

(5) Preferably, the adhesive film sticking apparatus (2) further comprises a setting device for setting the predetermined feeding amount according to various sizes of the plurality of adhesive films, wherein the control device controls the tape feed device to feed the film supply tape based on the predetermined feeding amount set by the setting device according to various sizes of the adhesive films.

According to the above mentioned apparatus (1), when the adhesive film adhered on the base tape of the film supply tape to be fed by the tape feed device, the edge of the adhesive film is detected based on detection of the predetermined displacement amount of the contactor of the detection device displaceable in a direction of the width of the adhesive film, and also the tape feed device is controlled by the control device based on the detection signal output from the detection device to feed the film supply tape by the predetermined feeding amount until the front end of the adhesive film is disposed near the fold-back point. With this structure, even where the adhesive films adhered and arranged at the predetermined intervals on the base tape are films having a light transmitting property, the edge of each adhesive film can definitely be detected through the contactor of the detection device, and each adhesive film can be set in the predetermined sticking position corresponding to the fold-back point of the film supply tape. Even when the path length of the film supply tape existing between the position of the detection device placed and the fold-back point of the film supply tape is set at a fixed length, the film supply tape is fed by the predetermined amount according to each of various-sized adhesive films. The adhesive film sticking apparatus of the invention can flexibly be operated for the adhesive films of any size and set each adhesive film in the predetermined sticking position.

The above sticking apparatus is arranged such that, based on the detection signal output when the detection device detects the edge of each adhesive film, the tape feed device feeds the film supply tape by the predetermined amount, setting each adhesive film in the predetermined sticking position corresponding to the fold-back point of the film supply tape. The position of the detection device placed in the sticking apparatus can freely be set, which makes it possible to hold a high level of the design freedom of the sticking apparatus.

According to the adhesive film sticking apparatus (2), the control device changes the predetermined feeding amount of the film supply tape to be fed by the tape feed device, according to each of different sizes of the adhesive films. After the detection device detects the edge of each adhesive film, the film supply tape can be fed by changing the predetermined feeding amount of the tape according to the size of each adhesive film. Thus, the adhesive films of any size can be set individually in the predetermined sticking position.

The adhesive film sticking apparatus (3) further comprises the guide bar having a flat support surface placed to face the roller contactor of the detection device having the rotatable roller, interposing the film supply tape between the guide bar and the roller contactor. For detection of each adhesive film on the film supply tape, the roller contactor is pressed against the support surface of the guide bar. Accordingly, the detection device can definitely detect the displacement of the roller contactor corresponding to the thickness of each adhesive film, thereby stably detect the end of each adhesive film.

The adhesive film sticking apparatus (4) is arranged such that the roller contactor of the detection device is separated from the support surface of the guide bar during non-operation in which the tape feed device does not feed the film supply tape. Accordingly, the work of placing the film supply tape along the predetermined path in the sticking apparatus is easily achieved. Further, it is possible to certainly prevent unnecessary stress on the roller contactor to stably keep the detection accuracy of the detection device for a long term.

The adhesive film sticking apparatus (5) is arranged such that the predetermined feeding amount can be set by means of the setting device according to each of different sizes of the adhesive films, and the control device controls the tape feed device to feed the film supply tape based on the predetermined feeding amount corresponding to each size set by the setting device. The sticking apparatus can flexibly be operated for the adhesive films of any size and reliably feed the film supply tape by the predetermined amount.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a side view of an adhesive film sticking apparatus;

FIG. 2 is an enlarged view of a film sticking unit attached to the adhesive film sticking apparatus;

FIG. 3 is a perspective enlarged view of a film supply tape;

FIG. 4 is an enlarged view of a detection sensor and its periphery;

FIG. 5 is a further enlarged view of the detection sensor;

FIG. 6 is a schematic plan view showing a relationship between the detection sensor and a guide bar;

FIG. 7 is a schematic enlarged view of the guide member and its periphery;

FIG. 8 is a schematic explanatory view of a driving system for the adhesive film sticking apparatus; and

FIGS. 9A to 9D are explanatory views showing an operation of peeling the adhesive film by means of the guide member and an operation of sticking the adhesive film by means of a sticking roller.

### DETAILED DESCRIPTION OF THE PREFERRED EMBODIMENTS

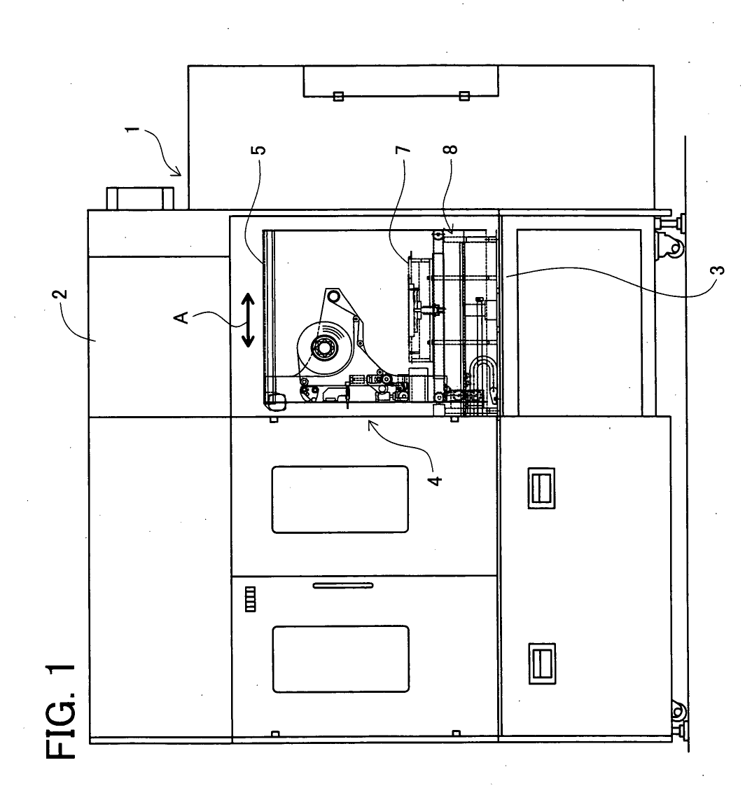

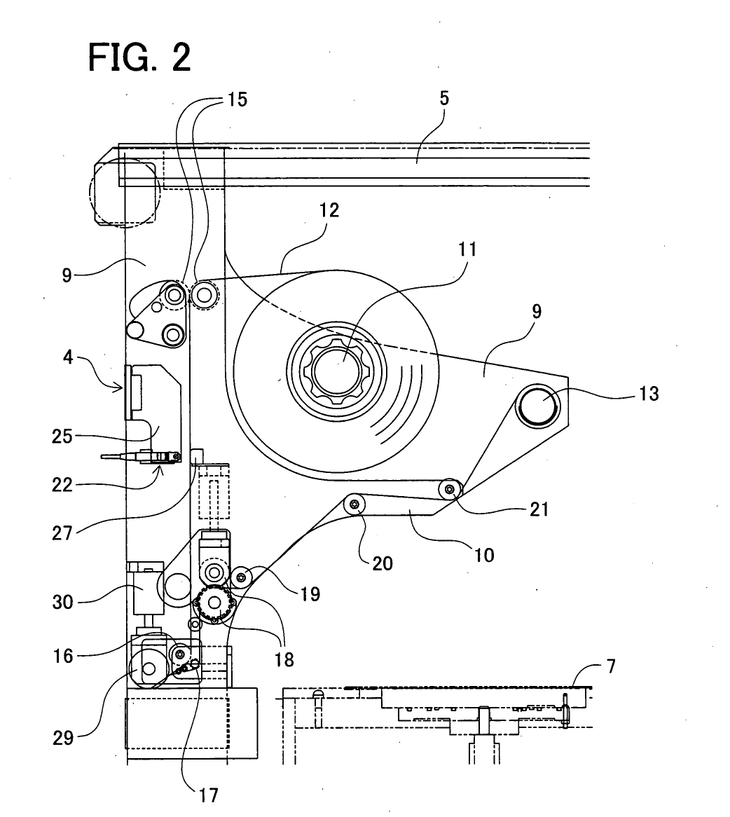

A detailed description of a preferred embodiment of an adhesive film sticking apparatus embodying the present invention will now be given referring to the accompanying drawings. At first, a schematic structure of the adhesive sticking apparatus in the present embodiment will be explained with reference to FIGS. 1 and 2. FIG. 1 is a side view of the adhesive film sticking apparatus. FIG. 2 is an enlarged view of a film sticking unit attached to the adhesive film sticking apparatus.

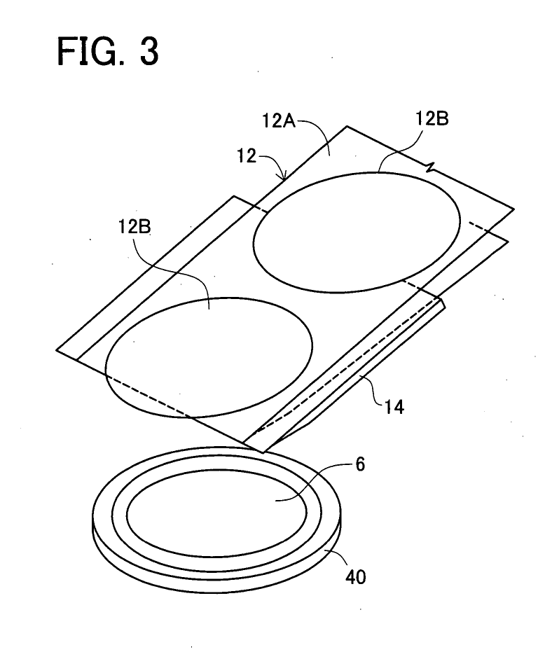

In FIGS. 1 and 2, the adhesive film sticking apparatus 1 includes an apparatus body 2 containing a work base 3 on which a sticking unit 4 is mounted. This sticking unit 4 is suspended from a rail 5 built in the apparatus body 2 and is arranged to reciprocate in a direction indicated by an arrow A in FIG. 1 by means of a driving device not shown. Placed below the sticking unit 4 is a driving mechanism 8 for moving up and down a table 7 on which a semiconductor substrate 6 (see FIG. 3) is placed or moving various works provided in the sticking apparatus 1. It should be noted that the structure of the driving mechanism 8 is well known and its detailed description is herein omitted.

As shown in FIG. 2, the sticking unit 4 includes a pair of main frames 9 (FIG. 2 shows only one main frame 9 disposed on the far side relative to the drawing sheet) which are suspended from the rail 5. A pair of side frames 10 (FIG. 2 shows only one side frame 10 disposed on the far side relative to the drawing sheet) is provided inside the main frames 9 respectively.

Rotatably supported between the main frames 9 is a reel shaft 11 on which a film supply tape 12 (mentioned later) is wound in a rolled state. Also, a take-up shaft 13 is supported between the main frames 9 to wind a base tape 12A after an adhesive film 12B is peeled from the film supply tape 12 as described later.

A structure of the film supply tape 12 is explained below with reference to FIG. 3. FIG. 3 is a perspective enlarged view of the film supply tape. In FIG. 3, the film supply tape 12 is formed of a base tape 12A made of a continuous strip-shaped transparent film and adhesive films 12B each being colorless and of a light transmittance property and adhered. The adhesive films 12B are adhered on the base tape 12A and spaced at predetermined intervals in a longitudinal direction of the base tape 12A. Each adhesive film 12B is designed to be smaller in outer diameter than a ring frame 40 positioned in place on the sticking table 7.

It is to be noted that the film supply tape 12 structured as above is folded back by a front edge of a guide member 14 formed like a knife edge and is guided toward the take-up shaft 13. In this embodiment, when the film supply tape 12 is folded back by the front edge of the guide member 14, the adhesive film 12B is peeled from the base tape 12A and stuck on the semiconductor substrate 6 and the ring frame 40 integrally. This sticking operation of the adhesive film 12B will be mentioned later.

Between the side frames 10, a pair of feeding rollers 15, guide rollers 16 and 17, a pair of drawing rollers 18, and three guide rollers 19, 20, and 21 are rotatably placed in this order along the feeding direction of the film supply tape 12 from the upstream side thereof.

One of the feeding rollers 15 is driven by a motor not shown to rotate, thereby reeling out the film supply tape 12 from the reel shaft 11.

A detection sensor 22 is placed in a substantial center between the feeding rollers 15 and the guide roller 16 to detect the adhesive film 12B on the film supply tape 12.

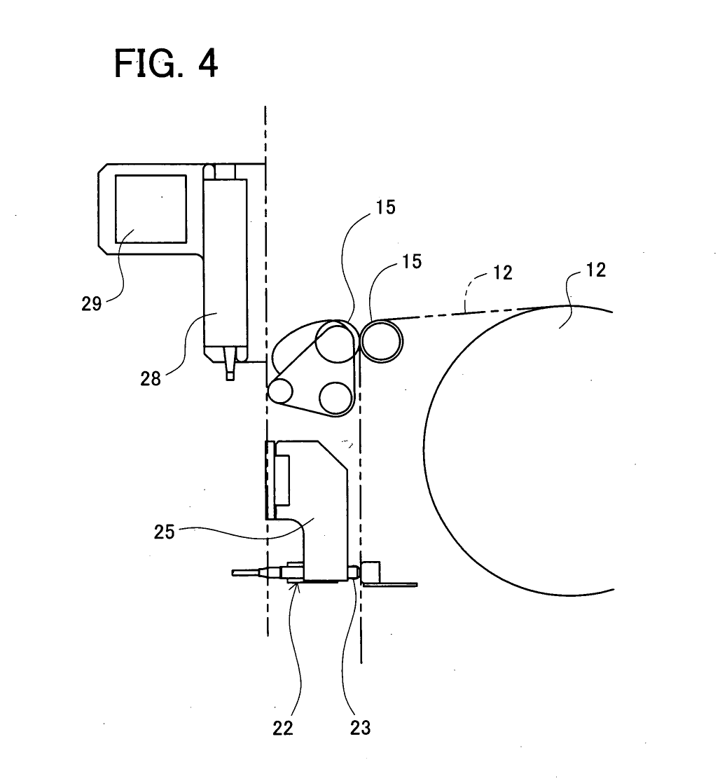

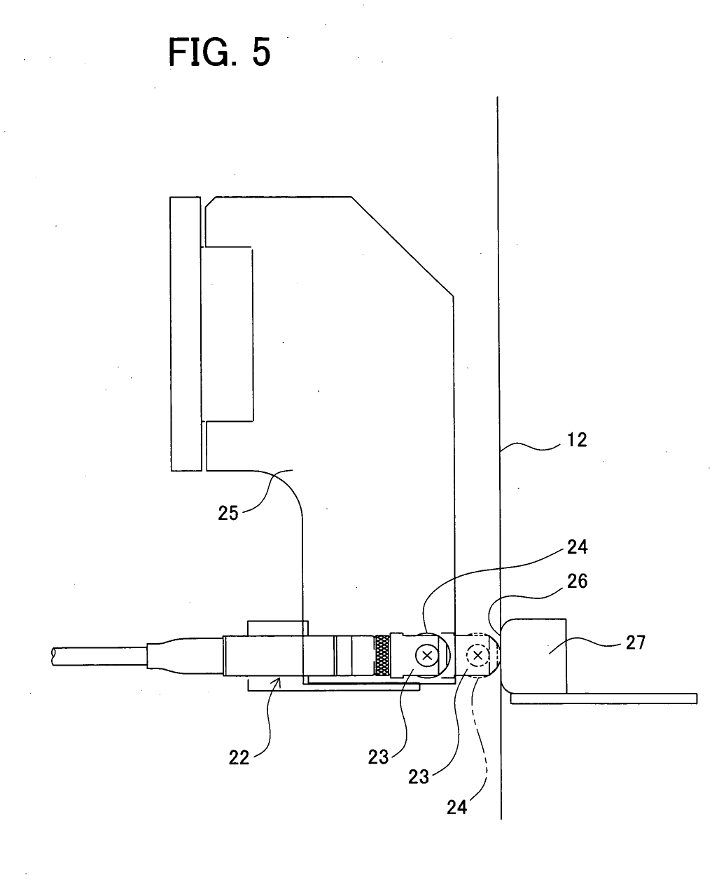

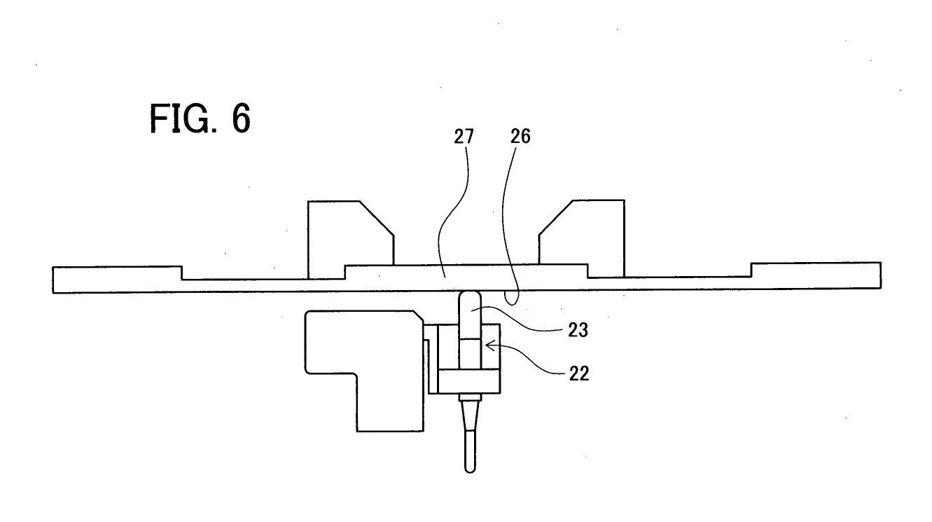

A structure of the detection sensor 22 is explained below with reference to FIGS. 4 to 6. FIG. 4 is an enlarged view of the detection sensor and its periphery; FIG. 5 is a further enlarged view of the detection sensor; and FIG. 6 is a schematic plan view showing a relationship between the detection sensor and a guide bar.

The detection sensor 22 consists of a so-called displacement sensor used for measuring the thickness of, e.g., a thin film. This sensor 22 is provided with a roller contactor 23 which can be displaced in a direction (a right-and-left direction in FIGS. 2, 4, and 5) corresponding to the thickness of the adhesive film 12B adhered on the base tape 12A of the film supply tape 12 being fed via the feeding rollers 15. A rotatable roller 24 is attached to an end of the roller contactor 23. The detection sensor 22 is mounted on the main frame 9 through a mounting base 25. A guide bar 27 having a flat support surface is placed facing the roller contactor 23 of the detection sensor 22 through the film supply tape 12 interposed therebetween.

The detection sensor 22 is internally provided with an urging spring which urges the roller contactor 23 leftwards in FIGS. 4 and 5 and also an electromagnet (not shown) for moving the roller contactor 23 rightwards in FIGS. 4 and 5 against the urging force of the spring.

In the operation of sticking the adhesive films 12B, the electromagnet is activated, causing the roller contactor 23 to project rightwards in FIGS. 4 and 5 against the urging force of the spring. The roller 24 of the roller contactor 23 is brought into contact with the support surface 26 of the guide bar 27 through the film supply tape 12 fed via the feeding rollers 15. As the adhesive film 12 is transported as above in the state where the roller 24 is in contact with the film supply tape 12, the roller 24 comes into contact with the front end of the adhesive film 12. The roller 24 is then gradually displaced leftwards due to the thickness of the adhesive film 12B. At the time when the leftward displacement amount (distance) of the roller 24 exceeds a predetermined value, a signal representing the detection of the adhesive film 12B is transmitted to and amplified in an amplifier 28 (see FIG. 4) placed above the detection sensor 22. The amplified signal is then output to a sequencer 33 mentioned later through a controller 39 provided in the amplifier 28.

In the case where no operation of sticking the adhesive film 12B is performed, the electromagnet in the detection sensor 22 is deactivated, allowing the roller contactor 23 to be urged leftwards by the urging force of the urging spring. The roller 24 of the roller contactor 23 is thus separated from the support surface 26 of the guide bar 27.

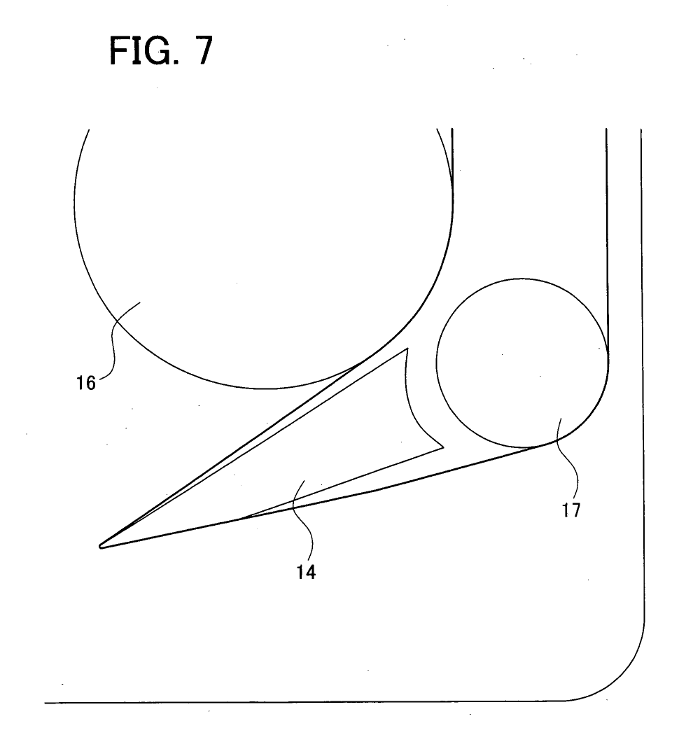

Returning to FIG. 2 for further explanation, the guide member 14 having a front edge formed like a knife edge as shown in FIG. 7 is placed between the guide rollers 16 and 17. This guide member 14, at its front edge, folds back the film supply tape 12 transported from the reel shaft 11 through the feeding rollers 15. This folding-back by the guide member 14 causes the adhesive film 12B adhesively provided on the film supply tape 12 to peel from the base tape 12A.

Placed near the edge of the guide member 14 is a sticking roller 29 movable up and down. In the operation of sticking the adhesive film 12B, the sticking unit 4 is moved along the rail 5 toward the table 7 until the adhesive film 12B having been peeled from the base tape 12A is set in the sticking start position in the ring frame 40 placed on the table 7. Thereafter, this sticking roller 29 is moved down by an air cylinder 30 to press the adhesive film 12B, thereby sticking the adhesive film 12B onto the surfaces of the ring frame 40 and semiconductor substrate 6. This operation is performed sequentially in association with the movement of the sticking unit 4.

Further, the base tape 12A from which the adhesive film 12B has been peeled through the guide member 14 is drawn by the pair of drawing rollers 18 (a lower one is rotatably driven) and guided by the guide rollers 19, 20, and 21 in order and wound on the take-up shaft 13. It should be noted that the take-up shaft 13 is rotatably driven in sync with the feeding rollers 15 and the drawing rollers 18 mentioned above.

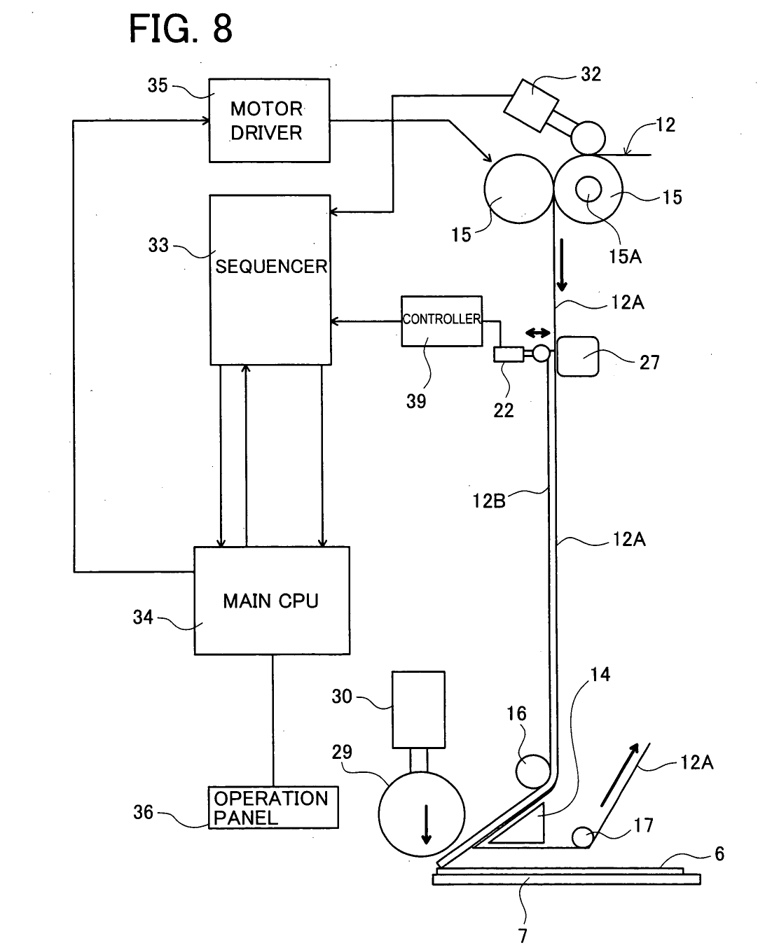

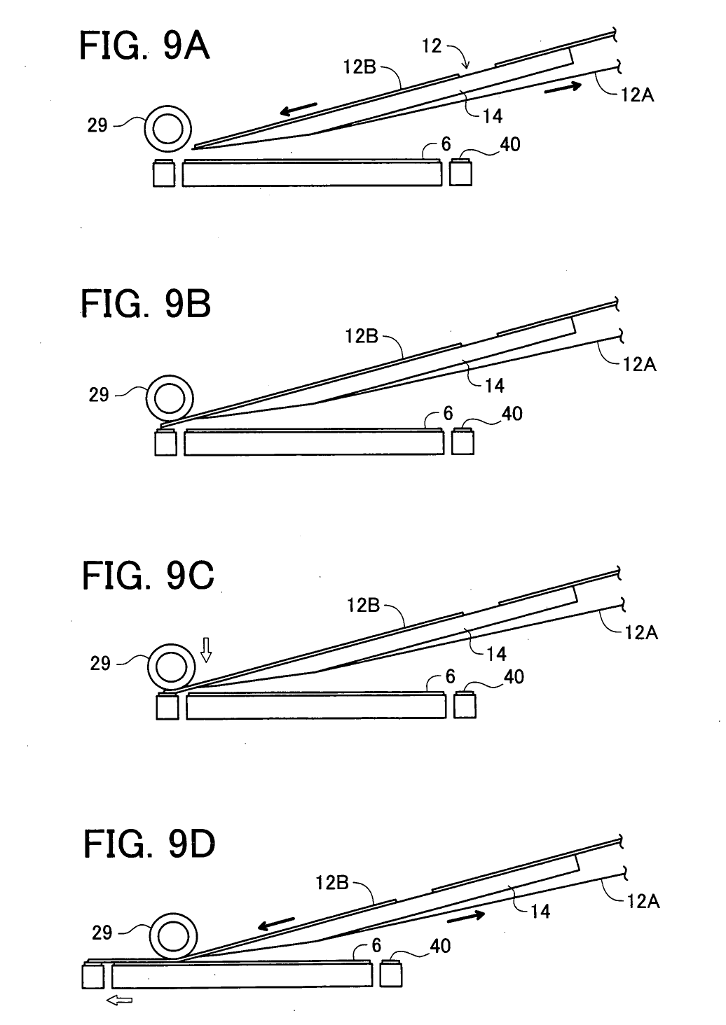

The operation of the film sticking apparatus 1 constructed as above will be explained below with reference to FIGS. 8 and 9. FIG. 8 is a schematic explanatory view of a driving system for the adhesive film sticking apparatus; and FIGS. 9A to 9D are explanatory views showing an operation of peeling the adhesive film by means of the guide member and an operation of sticking the adhesive film by means of the sticking roller.

The driving system of the film sticking apparatus is first described, referring to FIG. 8. In FIG. 8, one of the feeding rollers 15 is provided with an encoder 32 which counts the fixed number of slits formed in an encoder plate (not shown) attached to a roller shaft 15A of the feeding roller 15 and outputs encoder pulses every rotation of the encoder plate to the sequencer 33.

The controller 39 provided in the detection sensor 22 is connected to the sequencer 33. When the adhesive film 12B on the base tape 12A is detected through the roller contactor 23 of the detection sensor 22 as mentioned above, the detection signal from the controller 39 is transmitted to the sequencer 33.

Furthermore, the sequencer 33 is connected to a main CPU 34 for allowing communications of various signals thereto. A driving motor (not shown) for rotatably driving the feeding rollers 15 is connected to a motor driver 35 which controls the rotation of the driving motor. Specifically, this motor driver 35 controls the rotation of the driving motor based on the control signals from the main CPU 34.

An operating panel 36 for setting various conditions is connected to the main CPU 34. For example, the size of the adhesive film 12B to be used varies according to the size of the ring frame 40. In the case where the size of the ring frame 40 is changed, therefore, a feeding amount of the film supply tape 12 is set through the operating panel 36 according to the size of the ring frame 40.

The operation of sticking the adhesive film 12B, which is performed by the driving system, is explained below. By operation of the operating panel 36, the feeding amount of the film supply tape 12 is set according to the size of the adhesive film 12B corresponding to the size of the ring frame 40 to be used in the adhesive film sticking apparatus 1. At this time, the size of the ring frame 40 is usually one of a plurality of predetermined different sizes. Accordingly, a plurality of feeding amounts of the film supply tape 12 corresponding to the sizes of the ring frames 40 may be set in advance to allow a selection of the desired feeding amount from among the predetermined different feeding amounts.

Upon start of the sticking operation of the adhesive film 12B, the electromagnet in the detection sensor 22 is activated, causing the roller contactor 23 to come into contact with the support surface 26 of the guide bar 27 through the film supply tape 12. Simultaneously, the motor driving signal is transmitted from the main CPU 34 to the motor driver 35. Based on the motor driving signal from the main CPU 34, the motor driver 35 is caused to rotatably drive the motor, which rotates the feeding rollers 15. Accordingly, the film supply tape 12 formed from the base tape 12A and the adhesive films 12B adhesively arranged at predetermined intervals on the base tape 12A is fed by the feeding rollers 15. The front end of the adhesive film 12B is detected by the detection sensor 22 through the roller contactor 23, the detection signal from the detection sensor 22 is amplified in the amplifier 28 and then transmitted to the sequencer 33 via the controller 39.

Upon receipt of the signal indicating the detection of the adhesive film 12B from the detection sensor 22, the sequencer 33 transmits a signal indicating the reception of the detection signal to the main CPU 34. Based on this signal, the CPU 34 generates a command signal for start of an operation of positioning the adhesive film 12B to the sequencer 33. The detection signal from the detection sensor 22 also serves as a trigger signal to cause the sequencer 33 to start counting the encoder pulses output from the encoder 32. When the number of pulses counted reaches a predetermined count corresponding to the predetermined feeding amount set through the operating panel 36, the sequencer 33 generates a signal indicating to that effect to the main CPU 34.

The main CPU 34 generates a signal for stopping the motor that rotatably drives the feeding rollers 15 to the motor driver 35. Thus the motor driver 35 stops the rotation of the motor, stopping the rotation the feeding rollers 15. At this time, the front end of the adhesive film 12B is peeled from the base tape 12A by means of the guide member 14 as shown in FIG. 8.

Thereafter, the sticking unit 4 is moved rightwards in FIG. 2 by a predetermined distance from the position thereof shown in FIG. 2. The sticking roller 29 is set just above the front end of the peeled adhesive film 12B, as shown in FIG. 8. The sticking roller 29 is then moved down by the air cylinder 30 to the sticking start position of the adhesive film 12B. At this time, the front end of the peeled adhesive film 12B is pressed and stuck onto the ring frame 40 set in the predetermined position on the table 7. Simultaneously, the sticking unit 4 is moved rightwards in FIG. 8 and the base tape 12A of the film supply tape 12 is sequentially guided toward the take-up shaft 13 by operation of the drawing rollers 18 and the take-up shaft 13, which are driven to rotate in sync with the feeding rollers 15. In such state, the adhesive film 12B on the film supply tape 12 is accordingly peeled from the base tape 12A by the guide member 14 and stuck on the ring frame 40 and the semiconductor substrate 6 by the sticking roller 29 at the same time.

Herein, the following explanation is made referring to FIG. 9 about the operation of sticking the adhesive film 12B integrally onto the ring frame 40 and the semiconductor substrate 6 by means of the sticking roller 29 while peeling the adhesive film 12B from the film supply tape 12 by means of the guide member 14. FIGS. 9A to 9D are explanatory views showing the operation of peeling the adhesive film by means of the guide member and the an operation of sticking the adhesive film by means of the sticking roller.

In FIG. 9, as described above, after the front end of the adhesive film 12B existing on the base tape 12A is detected through the roller contactor 23 in the detection sensor 22, the film supply tape 12 is fed by the predetermined feeding amount by operation of the feeding rollers 15, the drawing rollers 18, and the take-up shaft 13 until the number of counted encoder pulses output from the encoder 32 reaches the predetermined count. At the time when the number of counted encoder pulses reaches the predetermined count, i.e., when the film supply tape 12 is fed by the predetermined feeding amount, the feed of the film supply tape 12 is stopped. This state is shown in FIG. 9B. At this stage, the front end of the adhesive film 12B with the front end being slightly peeled is disposed just below the sticking roller 29.

Then, the sticking roller 29 is moved down from the state shown in FIG. 9B by the air cylinder 30. The front end of the adhesive tape 12B is stuck on the ring frame 40, slightly inside the outer edge thereof, set in place on the table 7. This state is shown in FIG. 9C.

Furthermore, the sticking unit 4 is moved rightwards in FIG. 9, and the film supply tape 12 is transported sequentially toward the take-up shaft 13 by operation of the drawing rollers 18 and the take-up shaft 13 which are driven to rotate in sync with the rotation of the feeding rollers 15. This allows the adhesive films 12B on the film supply tape 12 to be peeled in sequence from the base tape 12A by the guide member 14 and simultaneously stuck on the ring frame 40 and the semiconductor substrate 6 integrally by the sticking roller 29.

In the film sticking apparatus 1 in the present embodiment, as explained above in detail, the film supply tape 12 with the adhesive film 12B adhesively provided on the base tape 12A is fed from the reel shaft 11 by cooperation of the feeding rollers 15, drawing rollers 18, and take-up shaft 13. The detection of such adhesive film 12B is performed by detecting the front end of the adhesive film 12B based on that the predetermined displacement amount is detected through the roller contactor 23 of the detection sensor 22 displaceable in the direction of width of the adhesive film 12B. The feeding rollers 15 and others are controlled through the main CPU 34, sequencer 33, motor driver 35, and others based on the detection signal output from the detection sensor 22 to feed the film supply tape 12 by the predetermined feeding amount until the front end of the adhesive film 12B comes to near the fold-back point of the film supply tape 12 by the guide member 14. Even where the adhesive films 12B adhered at the predetermined intervals on the base tape 12A is a colorless film having a light transmittance property, the front end of each adhesive film 12B can reliably be detected through the roller contactor 23 of the detection sensor 22. This makes it possible to place the front end of each adhesive film 12B in the predetermined sticking point corresponding to the fold-back point of the film supply tape 12.

In the case where the path length of the film supply tape 12 existing between the position of the detection sensor 22 placed and the fold-back point of the film supply tape 12 is set at a fixed length, the film supply tape 12 is fed by the predetermined amount according to the size of each available adhesive film 12B. Accordingly, the film sticking apparatus 1 can flexibly be operated for various types of adhesive films 12B having different sizes, and therefore the adhesive film 12B of a selected size can be set in the predetermined sticking position.

Moreover, the film sticking apparatus 1 is structured such that, the film supply tape 12 is fed by the predetermined amount by means of the feeding rollers 15 and others based on the detection signal output from the detection sensor 22 that detects the front end of the adhesive film 12B so that the adhesive film 12B is set in the predetermined sticking position corresponding to the fold-back point of the film supply tape 12. Thus, the position of the detection sensor 22 placed in the film sticking apparatus 1 can freely be determined, which can maintain a high level of design freedom of the film sticking apparatus 1.

By operation of the operating panel 36, further, it is possible to appropriately set the predetermined feeding amount of the film supply tape 12 to be fed by the feeding rollers 15 and others according to each size of the plurality of adhesive films 12B having different sizes. This makes it possible to feed the film supply tape 12 while changing the predetermined feeding amount of the film supply tape 12 according to each size of the adhesive films 12B. Thus, the adhesive films 12B of any size can be set individually in the predetermined sticking position.

Furthermore, the guide bar 27 having the flat support surface 26 is placed facing the roller contactor 23 of the detection sensor 22 having the rotatable roller 24 through the film supply tape 12. Accordingly, for detecting the adhesive film 12B on the film supply tape 12, the roller contactor 23 is pressed against the support surface 26 of the guide bar 27, so that the displacement of the roller contactor 23 corresponding to the thickness of the adhesive film 12B can surely be detected. Consequently, the front end of the adhesive film 12B can be detected stably.

During non-operation where the film supply tape 12 is not fed by the feeding rollers 15 and others, the electromagnet in the detection sensor 22 is deactivated, separating the roller contactor 23 in the detection sensor 22 from the support surface 26 of the guide bar 27 by means of the urging spring. The film supply tape 12 can easily be placed along the predetermined path in the film sticking apparatus 1. It is reliably possible to minimize unnecessary stress on the roller contactor 23 and hence to hold the stable detection accuracy of the detection sensor 22 for a long term.

The predetermined feeding amount of each of the adhesive films 12B having different sizes can be set according to each size through the operating panel 36. The main CPU 34, sequencer 33, and others control the feeding rollers 15 and others to feed the film supply tape 12 based on the predetermined feeding amount corresponding to each size set through the operating panel 36. Even where the size of the adhesive film 12B is changed to another size, it is possible for the film sticking apparatus 1 to flexibly operate for the changed size, reliably feeding the film supply tape 12 by the predetermined feeding amount.

The present invention may be embodied in other specific forms without departing from the spirit or essential characteristics thereof.

For instance, in the above embodiment, it is arranged to detect the front end of each adhesive film 12B of the film supply tape 12 by means of the roller contactor 23 of the detection sensor 22. Since the film supply tape 12 can be fed by the predetermined feeding amount only after either end of each adhesive film 12B is detected, for example a rear end of each adhesive film 12B instead of the front end thereof may be detected.

In the above embodiment, the table 7 on which the ring frame 40 and semiconductor substrate 6 are placed has been fixed before the sticking of the adhesive films 12B onto the ring frame 40, and the sticking unit 4 is moved and the operation of sticking each adhesive film 12B is repeated. However, the invention is not limited to such structure. For instance, the sticking unit 4 and the sticking table 7 may be structured to allow relative movement. In other words, if the sticking unit 4 and the sticking table 7 are relatively movable, the above mentioned operation of sticking each adhesive film 12B can be conducted.

In the above embodiment, furthermore, the predetermined feeding amount of the film supply tape 12 is set in advance through the operating panel 6 according to the film size of the adhesive film 12B corresponding to the size of the ring frame 40, and the film supply tape 12 is fed based on the predetermined feeding amount set in advance. However, the invention is not limited to such structure. For instance, a sensor for detecting the size of the adhesive film 12B may be provided. In this case, the predetermined feeding amount of the film supply tape 12 having been stored in advance in correspondence with the size of each adhesive film 12B detected by the sensor is read, and the film supply tape 12 is fed based on the read predetermined feeding amount.

Although the adhesive film 12B in the above embodiment is stuck onto the semiconductor substrate 6 and the ring frame 40 integrally, the adhesive film 12B may be stuck directly on only the semiconductor substrate 6.

The present invention, as described above, makes it possible to provide an adhesive film sticking apparatus capable of setting an adhesive film in a predetermined sticking position by reliably detecting an end of the adhesive film adhesively arranged at predetermined intervals on a base tape even where the adhesive film is a film having a light transparent property, and also capable of flexibly operating for various types of adhesive films different in size to set the adhesive films of any size in a predetermined sticking position.

What is claimed is:

1. An adhesive film sticking apparatus comprising:
a tape feed device for feeding a film supply tape on which adhesive films each having a predetermined shape are arranged at predetermined intervals in a longitudinal direction of a base tape;
a film peeling device for guiding the film supply tape to be folded back to a fold-back point and peeling each adhesive film from the base tape at the fold-back point;
a sticking roller placed near the fold-back point and to be movable in an up and down direction; and
a sticking table for placing thereon substrates on each of which the adhesive film is to be stuck;
the sticking roller and the sticking table being moved relatively to each other, thereby sequentially peeling each adhesive film from the base tape by the film peeling device and sticking each adhesive film onto each substrate by the sticking roller,
wherein the adhesive film sticking apparatus further comprises:
a detection device including a contactor displaceable in a direction of thickness of each adhesive film adhesively provided on the base tape of the film supply tape to be fed by the tape feed device, the detection device being adapted to detect an end of each adhesive film when a predetermined displacement of the contactor is detected; and
a control device for controlling the tape feed device based on a detection signal output from the detection device so that the film supply tape is fed by a predetermined feeding amount until a front end of the adhesive film comes to near the fold-back point.

2. The adhesive film sticking apparatus according to claim 1, wherein the adhesive film adhesively provided on the base tape includes a plurality of adhesive films of various sizes, and
the control device changes the predetermined feeding amount according to the size of each adhesive film.

3. The adhesive film sticking apparatus according to claim 2, wherein the contactor of the detection device comprises a roller contactor provided with a rotatable roller, and
the apparatus further comprises a guide bar having a flat support surface and being disposed facing the roller contactor through the film supply tape.

4. The adhesive film sticking apparatus according to claim 3, wherein the roller contactor is separated from the support surface of the guide bar during non-operation where the film supply tape is not fed by the tape feed device.

5. The adhesive film sticking apparatus according to claim 2 further comprising a setting device for setting the predetermined feeding amount according to various sizes of the plurality of adhesive films,
wherein the control device controls the tape feed device to feed the film supply tape based on the predetermined feeding amount set by the setting device according to various sizes of the adhesive films.
